(19) United States
(12) Patent Application Publication
(10) Pub. No.: US 2024/0293996 A1
(43) Pub. Date: Sep. 5, 2024

(54) OPTICAL UNIT AND METHOD FOR MANUFACTURING THE SAME

(71) Applicant: DAICEL CORPORATION, Osaka (JP)

(72) Inventors: Hiroki TAKENAKA, Tokyo (JP); Hiromi HONMA, Tokyo (JP); Takahiro IWAHAMA, Tokyo (JP)

(73) Assignee: DAICEL CORPORATION, Osaka (JP)

(21) Appl. No.: 18/411,228

(22) Filed: Jan. 12, 2024

(30) Foreign Application Priority Data
Mar. 2, 2023 (JP) 2023-032009

(51) Int. Cl. B32B 7/14; B32B 3/30; B32B 27/08; B32B 27/16; B32B 27/38; B32B 37/12; C09J 5/02

(52) U.S. Cl. CPC B32B 7/14; B32B 3/30; B32B 27/08; B32B 27/16; B32B 27/38; B32B 37/1292; C09J 5/02; B32B 2309/04; B32B 2310/0837; B32B 2310/14; B32B 2551/00; C09J 2400/228; C09J 2463/00

(57) ABSTRACT

Problem To make it possible to adhere a first substrate and a second substrate over the entire circumference of each lens portion by a simpler method.

Solution After a laminate is produced by adhering a second substrate 2 to a first substrate 1 which is a lens wafer having a plurality of lens portions 11 and formed of a curable resin, the laminate is cut between the lens portions 11, and a plurality of optical units are thus manufactured. Before the second substrate 2 is adhered to the first substrate 1, surface treatment of increasing surface free energy is performed on a surface 1a of the first substrate 1 opposing the second substrate 2. After the surface treatment, an adhesive is applied to the opposing surface 1a of the first substrate 1, and surrounds a lens portion 11 corresponding within a contour of each of the plurality of optical units. After the application of the adhesive, the second substrate 2 is superimposed on the first substrate 1, and the adhesive is cured.

### TECHNICAL FIELD

The present disclosure relates to a method for manufacturing an optical unit and an optical unit obtained by an aspect of the manufacturing method.

### BACKGROUND ART

In the related art, for simultaneously manufacturing a plurality of optical units, a method for manufacturing an optical unit using a lens wafer having a plurality of lens portions is known. Specifically, in this manufacturing method, first, a second substrate which is a lens wafer, a light shielding plate, or the like is adhered to a first substrate which is a similar lens wafer having a plurality of lens portions, and a laminate is thus produced. Thereafter, the laminate is cut between the lens portions, and a plurality of optical units are thus manufactured.

An adhesive is used for adhesion between the first substrate and the second substrate to each other. For example, Patent Document 1 discloses a method for manufacturing an optical unit using, as a first substrate and a second substrate, lens wafers (referred to as “wafer scale lenses” in Patent Document 1) in which lens portions are arranged in a matrix shape. On a surface of the first substrate opposing the second substrate, grooves are provided in a lattice shape, the grooves extending between the adjacent lens portions and crossing the opposing surface, and, on a surface of the second substrate opposing the first substrate, grooves are provided in a lattice shape, the grooves extending between the adjacent lens portions and crossing the opposing surface.

In the method for manufacturing an optical unit disclosed in Patent Document 1, first, the opposing surface of the first substrate and the opposing surface of the second substrate are brought into surface contact with each other, and a superimposed body is thus formed. At this time, the grooves of the first substrate and the grooves of the second substrate coincide with each other, thereby forming an injection space whose both ends are open to an end surface of the polymer of the first substrate and the second substrate. Thereafter, the injection space is filled with an adhesive and the adhesive is cured, thereby producing a laminate in which the first substrate and the second substrate are adhered to each other.

A width of the grooves provided in the opposing surface of the first substrate and a width of the grooves provided in the opposing surface of the second substrate are larger than a width of a dicing blade used for cutting the laminate. Therefore, after the laminate is cut, an optical unit in which an adhesive layer is present over the entire circumference of an outer peripheral surface which is a cut surface is obtained.

### CITATION LIST

### Patent Document

Patent Document 1: JP 5254139 B

### SUMMARY OF INVENTION

### Technical Problem

According to the method for manufacturing an optical unit of Patent Document 1, the first substrate and the second substrate are adhered to each other over the entire circumference of each lens portion. Therefore, when the laminate is cut, it is possible to prevent cutting powder or water used for cutting from entering gaps along the lens portions between the first substrate and the second substrate.

However, in the method for manufacturing an optical unit of Patent Document 1, the injection space which is formed by the grooves of the first substrate and the grooves of the second substrate and whose both ends are open to the end surface of the superimposed body of the first substrate and the second substrate is filled with the adhesive, and thus it is difficult to fill the injection space with the adhesive over the entire length without any gap.

Therefore, an object of the present disclosure is to make it possible to adhere the first substrate and the second substrate to each other over the entire circumference of each lens portion by a simpler method.

### Solution to Problem

The present disclosure provides a method for manufacturing a plurality of optical units by adhering a second substrate to a first substrate to produce a laminate, the first substrate being a lens wafer, the lens wafer including a plurality of lens portions and being formed of a curable resin, and then cutting the laminate between the plurality of lens portions, the method including: performing surface treatment of increasing surface free energy on an opposing surface of the first substrate opposing the second substrate before adhering the second substrate to the first substrate; applying an adhesive to the opposing surface of the first substrate after the surface treatment, the adhesive surrounding a lens portion corresponding within a contour of each of the plurality of optical units; and superimposing the second substrate on the first substrate and curing the adhesive after the application of the adhesive.

In addition, the present disclosure provides an optical unit including: a first element including a lens portion and formed of a curable resin; a second element overlapping the first element; and an adhesive layer containing a monodisperse spherical filler, the adhesive layer being interposed between the first element and the second element and surrounding the lens portion.

### ADVANTAGEOUS EFFECTS OF INVENTION

According to the present disclosure, the first substrate and the second substrate can be adhered to each other over the entire circumference of each lens portion by a simpler method.

### BRIEF DESCRIPTION OF DRAWINGS

FIG. 1 is a perspective view of a first substrate and a second substrate used in a method for manufacturing an optical unit according to an embodiment.

FIG. 2 is a perspective view of a laminate in which the first substrate and the second substrate are adhered to each other.

FIG. 3(a) is a cross-sectional view of the optical unit, and FIG. 3(b) is an enlarged view of a main part thereof.

FIG. 4 is a view for explaining a method for applying an adhesive to an opposing surface of the first substrate.

FIG. 5 is a view for explaining a method for applying an adhesive according to a first modification.

FIG. 6 is a view for explaining a method for applying an adhesive according to a second modification.

FIG. 7 is a view for explaining a method for applying an adhesive according to a third modification.

### DESCRIPTION OF EMBODIMENTS

Note that each of the configurations, combinations thereof, and the like in each of the embodiments which will be described below are an example, and various additions, omissions, substitutions, and other changes may be made as appropriate without departing from the spirit of the present disclosure. The present disclosure is not limited by the embodiments and is limited only by the claims. Each aspect disclosed in the present specification can be combined with any other feature disclosed herein.

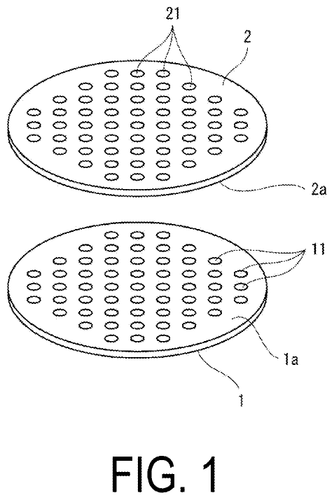

FIG. 1 shows a first substrate 1 and a second substrate 2 used in a method for manufacturing an optical unit according to an embodiment. The first substrate 1 and the second substrate 2 have a circular shape in the present embodiment, but may have another shape such as a square shape.

The first substrate 1 is a lens wafer having a plurality of lens portions 11. The lens portions 11 are arranged in a matrix shape. In the present embodiment, the second substrate 2 is also a lens wafer having a plurality of lens portions 21. The lens portions 21 are arranged in a matrix shape at the same pitch as the lens portions 11. However, the second substrate 2 may be a light shielding plate having an opening at a position corresponding to the lens portions 11 of the first substrate 1, or may be a spacer interposed between the lens wafer which is the first substrate 1 and another lens wafer.

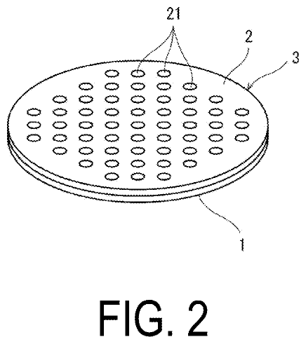

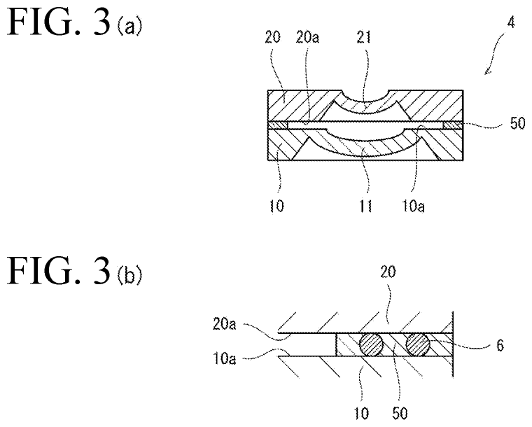

In the method for manufacturing an optical unit, first, the second substrate 2 is adhered to the first substrate 1, thereby producing a laminate 3, as illustrated in FIG. 2. In the present embodiment, a portion of a surface 1a (see FIG. 1) of the first substrate 1 opposing the second substrate 2, which is to be adhered to the second substrate 2, and a portion of a surface 2a (see FIG. 1) of the second substrate 2 opposing the first substrate 1, which is to be adhered to the first substrate 1, are flat. Thereafter, the laminate 3 is cut between the lens portions 11 and 21, and a plurality of optical units 4 are thus manufactured (see FIG. 3(a)).

The lens wafers serving as the first substrate 1 and the second substrate 2 are formed of a curable resin. The same curable resin may be used for the first substrate 1 and the second substrate 2, or different curable resins may be used for the first substrate 1 and the second substrate 2.

The curable resin is a resin that is cured by heating or irradiation with an active energy ray such as an ultraviolet ray or an electron beam. The curable resin is not particularly limited, and examples thereof include epoxy-based resins, acrylic-based resins, and silicone-based resins.

For example, the curable resin may contain any one of an alicyclic epoxy compound, a siloxane compound, and a cationically polymerizable compound. The alicyclic epoxy compound is a compound having an alicyclic ring substituted with at least one epoxy group. The siloxane compound is a compound that includes two or more epoxy groups in the molecule, and includes at least a siloxane skeleton including a siloxane bond (Si-O-Si). The cationically polymerizable compound is a compound having at least one cationically curable functional group.

When the laminate 3 is produced, before the second substrate 2 is adhered to the first substrate 1, surface treatment of increasing surface free energy is performed on the opposing surface 1a of the first substrate 1. Thus, wettability of the opposing surface 1a of the first substrate 1 is improved. Excimer treatment, plasma treatment, corona treatment, ultraviolet ozone treatment, or the like can be used as the surface treatment of increasing the surface free energy of the opposing surface 1a of the first substrate 1.

For example, in the excimer treatment, the first substrate 1 is disposed in a treatment chamber, and the opposing surface 1a of the first substrate is oxidized using an excimer lamp. An oxygen concentration in the treatment chamber is, for example, from 5 to 18%.

In the surface treatment of the opposing surface 1a of the first substrate 1, the surface free energy of the opposing surface 1a of the first substrate 1 is preferably set from 26 to 73 mJ/m². This is because, when the surface free energy is lower than 26 mJ/m², adhesive 5 is repelled from the opposing surface 1a of the first substrate 1 and the applied state cannot be maintained, and, when the surface free energy is greater than 73 mJ/m², the adhesive 5 wets and spreads on the opposing surface 1a of the first substrate 1 and the applied state cannot be maintained.

The surface free energy is calculated by the OWRK (Owens Wendt Rable Kaelble) method. A method for measuring a contact angle used in the OWRK method is defined in JIS K 6769. For example, the contact angles with water of the opposing surfaces 1a having surface free energy of from 26 to 73 mJ/m² are 26 degrees or more and 87 degrees or less. The surface free energy of the opposing surface 1a of the first substrate 1 is more preferably from 30 to 69 mJ/m², and further preferably from 34 to 65 mJ/m².

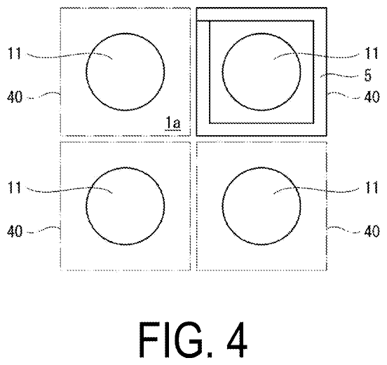

After the surface treatment of the opposing surface 1a of the first substrate 1, the adhesive 5 is applied to the opposing surface 1a of the first substrate 1, and surrounds a corresponding lens portion 11 within a contour 40 of each of the plurality of optical units 4, as illustrated in FIG. 4.

In the present embodiment, since the cutting between the adjacent lens portions 11 is performed only once, a distance between the contours 40 of the adjacent optical units 4 is the same as a width of a dicing blade used for cutting the laminate 3. However, the distance between the contours 40 of the adjacent optical units 4 may be made larger than the width of the dicing blade, and the cutting between the adjacent lens portions 11 may be performed a plurality of times.

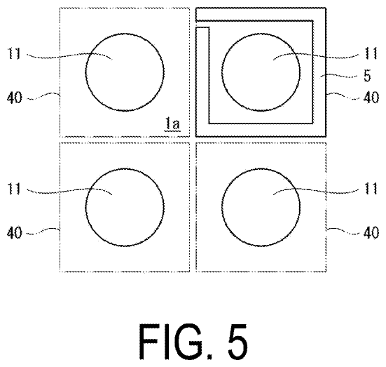

In FIG. 4, within the contour 40 of each optical unit 4, the adhesive 5 is applied and goes all around the lens portion 11 along four sides of the contour 40. Therefore, the adhesive 5 is applied around and over the entire circumference of each lens portion 11. However, as illustrated in FIG. 5, the adhesive 5 may be applied, and a portion where the adhesive 5 is finally applied may be separated from a portion where the adhesive 5 is initially applied. That is, as long as the adhesive 5 is applied around and substantially the entire circumference of each lens portion 11, a region where the adhesive 5 is not applied may be partially left around each lens portion 11.

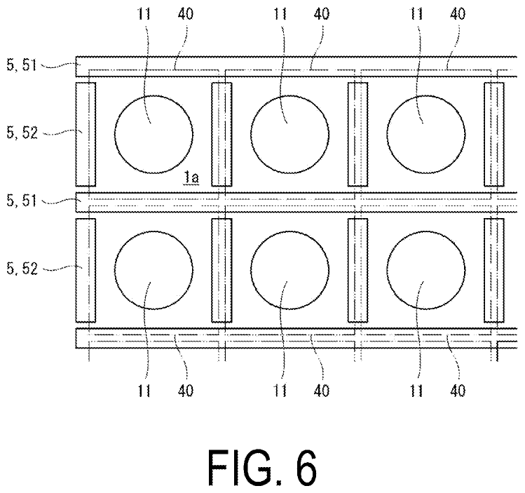

Alternatively, as illustrated in FIG. 6, the adhesive 5 may be applied parallel to a row of the lens portions 11 arranged in a matrix shape, thereby forming a band-shaped portion 51 wider than the distance between the contours 40 of the adjacent optical units 4, and then the adhesive 5 may be applied parallel to a column of the lens portions 11 arranged in a matrix shape between the band-shaped portions 51, thereby forming a strip portion 52 wider than the distance between the contours 40 of the adjacent optical units 4. In FIG. 6, the strip portion 52 is separated from the band-shaped portion 51, but the strip portion 52 may be connected to the band-shaped portion 51.

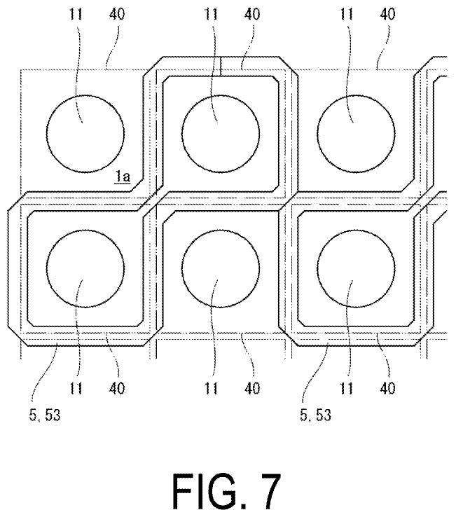

Further, as illustrated in FIG. 7, the adhesive 5 may be applied continuously surrounding two lens portions 11 positioned diagonally, among the four lens portions 11 arranged two by two in the vertical and horizontal directions, thereby forming an oblique eight-shaped portion 53. In this case, the adhesive 5 is applied every two pitches of the lens portions 11 in each of the row and the column.

In the present embodiment, a monodisperse spherical filler 6 (see FIG. 3(b)) is dispersed in the adhesive 5. The monodisperse spherical filler 6 is provided to ensure a certain clearance between a portion of the opposing surface 1a of the first substrate 1, which is to be adhered to the second substrate 2, and a portion of the opposing surface 2a of the second substrate 2, which is to be adhered to the first substrate 1. For example, the adhesive 5 contains an epoxy compound as a main component, and contains an oxetane compound, a photoacid generator (photoinitiator), a silane coupling agent, and the like as other components. The monodisperse spherical filler 6 is formed, for example, of a divinylbenzene polymer or silica.

Here, a group of fine particles having uniform particle characteristics such as particle size and shape are referred to as monodisperse fine particles, and the “monodisperse spherical filler” refers to a group of particles having a coefficient of variation (CV) value of 10% or less. The CV value is defined as a ratio of a standard deviation of a particle diameter distribution to a 50% average diameter. The CV value indicating the monodispersity of particles is defined as CV [%]=(σ/D)×100 (σ standard deviation, D: average particle diameter).

The particle size in the filler is, for example, from 1 to 100 μm. The particle size in the filler is preferably from 5 to 50 μm, and more preferably from 10 to 30 μm.

As a dispersion state of the filler in the adhesive 5, for example, the number of particles in the filler is from 1 to 1000 with respect to the adhesive 5 having a size of 1 mm². The number of particles in the filler with respect to the adhesive 5 having a size of 1 mm² is preferably from 10 to 200, and more preferably from 15 to 100.

After the application of the adhesive to the opposing surface la of the first substrate 1, the second substrate 2 is superimposed on the first substrate 1, and the adhesive 5 is cured. Thereafter, the laminate 3 is cut between the lens portions 11 and 21 as described above, and thus a plurality of optical units 4 are manufactured.

As illustrated in FIG. 3(a), each optical unit 4 includes a first element 10 having a lens portion 11, a second element 20 overlapping the first element 10 and having a lens portion 21, and an adhesive layer 50 interposed between the first element 10 and the second element 20 and surrounding the lens portion 11.

The first element 10 is a part of the first substrate 1, and thus is formed of the same curable resin as that for the first substrate 1. Similarly, the second element 20 is a part of the second substrate 2, and thus is formed of the same curable resin as that for the second substrate 2. The adhesive layer 50 is a part of the cured adhesive 5.

In the present embodiment, since the portion of the opposing surface 1a of the first substrate 1, which is to be adhered to the second substrate 2, and the portion of the opposing surface 2a of the second substrate 2, which is to be adhered to the first substrate 1, are flat as described above, a groove for accommodating the adhesive layer 50 is not formed in the opposing surface 10a of the first element 10 opposing the second element 20 and the opposing surface 20a of the second element 20 opposing the first element 10.

In the present embodiment, since the monodisperse spherical filler 6 is dispersed in the adhesive 5 used at the time of manufacturing the optical unit 4 as described above, the adhesive layer 50 contains the monodisperse spherical fillers 6 as illustrated in FIG. 3(b). That is, a thickness of the adhesive layer 50 is uniformly ensured by the monodisperse spherical filler 6.

The manufacturing method of the present embodiment described above can provide the following effects. In a case where the surface treatment of increasing the surface free energy is not performed on the opposing surface 1a of the first substrate 1, even when the adhesive 5 is applied to the opposing surface 1a of the first substrate 1 and surrounds the lens portion 11 within the contour 40 of each optical unit 4, the state is not maintained, and a phenomenon occurs in which the adhesive 5 is concentrated at a specific position. On the other hand, when the surface treatment of increasing the surface free energy is performed on the opposing surface 1a of the first substrate 1 as in the present embodiment, the state is maintained even after the adhesive 5 is applied and surrounds the lens portion 11 within the contour 40 of each optical unit 4. That is, the first substrate 1 and the second substrate 2 can be adhered to each other over the entire circumference of each lens portion 11 by a simple method of applying the adhesive 5 to the opposing surface 1a of the first substrate 1. Therefore, when the laminate 3 is cut, it is possible to prevent cutting powder or water used for cutting from entering gaps along the lens portions 11 between the first substrate 1 and the second substrate 2.

Incidentally, when the opposing surfaces of the first substrate and the second substrate are in surface contact with each other as in Patent Document 1, the adhesive may possibly pass between the opposing surfaces and enters the lens portions due to surface tension. In particular, when an adhesive having a low viscosity is used for facilitating filling of an injection space formed by a groove of the first substrate and a groove of the second substrate with the adhesive, the tendency is increased. On the other hand, such a problem can be prevented, when a clearance is provided between the portion of the opposing surface 1a of the first substrate 1 which is to be adhered to the second substrate 2 and the portion of the opposing surface 2a of the second substrate 2 which is to be adhered to the first substrate 1 as in the present embodiment.

### Modification

Although the monodisperse spherical filler 6 is dispersed in the adhesive 5 in the above embodiment, it is also possible to use an adhesive 5 which does not contain the monodisperse spherical filler 6. In this case, one of the first substrate 1 and the second substrate 2 is preferably provided with a contact portion that comes into contact with the other for the purpose of making constant thicknesses of the adhesive layers 50 after the adhesive 5 is cured (clearance between a portion of the opposing surface 1a of the first substrate 1, which is to be adhered to the second substrate 2, and a portion of the opposing surface 2a of the second substrate 2, which is to be adhered to the first substrate 1).

On the other hand, when the adhesive 5 in which the monodisperse spherical filler is dispersed is used as in the above embodiment, the thickness of the adhesive layer 50 can be kept constant only by the adhesive 5.

In addition, the portion of the opposing surface 1a of the first substrate 1 which is to be adhered to the second substrate 2 and the portion of the opposing surface 2a of the second substrate 2 which is to be adhered to the first substrate 1 are not necessarily flat. For example, grooves filled with the adhesive 5 may be formed in the portion of the opposing surface 1a of the first substrate 1 which is to be adhered to the second substrate 2 and the portion of the opposing surface 2a of the second substrate 2 which is to be adhered to the first substrate 1. In this case, in the manufactured optical unit 4, grooves for accommodating the adhesive layer 50 are formed in the opposing surface 10a of the first element 10 and the opposing surface 20a of the second element 20.

On the other hand, when the portion of the opposing surface 1a of the first substrate 1 which is to be adhered to the second substrate 2 and the portion of the opposing surface 2a of the second substrate 2 which is to be adhered to the first substrate 1 are flat as in the embodiment, strength of the first substrate 1 and the second substrate 2 can be ensured. In addition, in the manufactured optical unit 4, strength of the first element 10 and the second element 20 can be ensured.

### EXAMPLES

Hereinafter, the present disclosure will be described with reference to examples, but is not limited to the following examples.

An adhesive was applied in a linear shape on a surface of each of substrates of Comparative Example 1 and Examples 1 to 8, and it was confirmed whether or not the adhesive was maintained in a linear shape even after a lapse of time. As the adhesive, a UV-curable adhesive UVA-6790 K10 available from RESINOUS CORPORATION was used.

In Comparative Example 1, CELVENUS OTM107 available from Daicel Corporation was used as the substrate, and no surface treatment was performed. In Examples 1 to 3 and 6 to 8, the same CELVENUS OTM107 was used as the substrate, and surface treatment of increasing surface free energy was performed on the surface. In Examples 4 and 5, CELVENUS OTL101 available from Daicel Corporation was used as the substrate, and surface treatment of increasing the surface free energy was performed on the surface. CELVENUS OTM107 is formed of an epoxy-based resin and contains an alicyclic epoxy compound, a siloxane compound, and a cationically polymerizable compound, and CELVENUS OTL101 is formed of an epoxy-based resin and contains an alicyclic epoxy compound and a cationically polymerizable compound.

In Examples 1 to 5, a light irradiation device (SUS956 available from Ushio Inc.) was used, and excimer treatment in which the surface of the substrate was irradiated with excimer light was performed as the surface treatment. The conditions were as follows: the concentration of oxygen was 15%, the stage temperature was 40° C., and the light source height was 3 mm, and the irradiation time was varied in Examples 1 to 3 and 6 to 8. Specifically, the irradiation time was set to five seconds in Example 1, 30 seconds in Example 2, 300 seconds in Example 3, three seconds in Example 4, and 10 seconds in Example 5.

In Examples 6 to 8, corona discharge was performed, as the surface treatment, using a switchback automatic traveling corona treatment device (CTW-0212 available from WEDGE CO., LTD.). As the conditions, the applied power of the high-frequency power source was 0.2 KW, the height was set to 1 mm, and the number of times was varied in Examples 6 to 8. Specifically, the number of times was set to one in Example 6, four in Example 7, and eight in Example 8.

In addition, a contact angle of pure water or diiodomethane with respect to the surface of each of the substrates of Comparative Example 1 and Examples 1 to 8 (the surface after the surface treatment in Examples 1 to 8) was measured by a liquid drop method using a contact angle measuring device (DropMaster DM701 available from Kyowa Interface Science Co., Ltd.). The dropping amount was 2 μL, the waiting time was 1000 ms, and the mean value of the five point measurements was calculated.

Table 1 shows the substrate types and surface treatment conditions of Comparative Example 1 and Examples 1 to 8, as well as the contact angle measurement results and the observation results of the adhesive application state over time. In Table 1, Good indicates that the adhesive is maintained in a linear shape, and Poor indicates that the adhesive is not maintained in a linear shape or the height of the adhesive after application is changed.

TABLE 1

| | | | Contact angle [°] | | Surface | Adhesive application state | | | |
|---|---|---|---|---|---|---|---|---|---|
| | | | Pure | | free energy | Immediately | | | |
| | SUBSTRATE | Surface treatment | water | Diiodomethane | [mJ/m²] | after | 10 min | 30 min | 60 min |
| Comparative | 0TM107 | None | 97.1 | 65.2 | 25.8 | Poor | Poor | Poor | Poor |
| example 1 | | | | | | | | | |
| Example 1 | 0TM107 | Excimer treatment | 90.7 | 60.7 | 28.9 | Good | Good | Poor | Poor |
| Example 2 | 0TM107 | Excimer treatment | 86.4 | 59.0 | 30.5 | Good | Good | Good | Good |
| Example 3 | 0TM107 | Excimer treatment | 4.7 | 36.0 | 73.5 | Good | Good | Poor | Poor |
| Example 4 | 0TL101 | Excimer treatment | 72.4 | 39.8 | 42.8 | Good | Good | Good | Good |
| Example 5 | 0TL101 | Excimer treatment | 34.5 | 34.6 | 63.4 | Good | Good | Good | Good |
| Example 6 | 0TM107 | Corona discharge | 74.8 | 55.3 | 36.1 | Good | Good | Good | Good |
| Example 7 | 0TM107 | Corona discharge | 26.7 | 33.2 | 67.5 | Good | Good | Good | Good |
| Example 8 | 0TM107 | Corona discharge | 26.5 | 32.9 | 67.6 | Good | Good | Good | Good |

It can be seen from Table 1 that, when the treatment of increasing surface free energy is performed on the surface of the substrate, the adhesive is maintained in a linear shape for 10 minutes or longer. In particular, in Examples 2 and 4 to 8 in which the surface free energy was set from 30 to 73 mJ/m², the adhesive was maintained in a linear shape in a good state even after a lapse of 60 minutes.

### Conclusion

As a first aspect, the present disclosure provides a method for manufacturing a plurality of optical units by adhering a second substrate to a first substrate to produce a laminate, the first substrate being a lens wafer, the lens wafer including a plurality of lens portions and being formed of a curable resin, and then cutting the laminate between the plurality of lens portions, the method including: performing surface treatment of increasing surface free energy on a surface of the first substrate opposing the second substrate before adhering the second substrate to the first substrate; applying an adhesive to the opposing surface of the first substrate after the surface treatment, the adhesive surrounding a lens portion corresponding within a contour of each of the plurality of optical units; and superimposing the second substrate on the first substrate and curing the adhesive after the application of the adhesive.

In a case where the surface treatment of increasing the surface free energy is not performed on the opposing surface of the first substrate, even when the adhesive is applied to the opposing surface of the first substrate and surrounds the lens portion within the contour of each optical unit, the state is not maintained, and a phenomenon occurs in which the adhesive is concentrated at a specific position. On the other hand, when the surface treatment of increasing the surface free energy is performed on the opposing surface of the first substrate as in the above configuration, the state is maintained even after the adhesive is applied and surrounds the lens portion within the contour of each optical unit. That is, the first substrate and the second substrate can be adhered to each other over the entire circumference of each lens portion by a simple method of applying the adhesive to the opposing surface of the first substrate.

As a second aspect, in the first aspect, for example, the surface free energy of the opposing surface of the first substrate may be set from 26 to 73 mJ/m² when the surface treatment of increasing the surface free energy is performed on the opposing surface of the first substrate.

As a third aspect, in the first or second aspect, a monodisperse spherical filler may be dispersed in the adhesive. According to this configuration, the thickness of the adhesive layer after curing of the adhesive can be kept constant only by the adhesive.

As a fourth aspect, in any one of the first to third aspects, a portion of the opposing surface of the first substrate, which is to be adhered to the second substrate, may be flat, and a portion of an opposing surface of the second substrate opposing the first substrate, which is to be adhered to the first substrate, may be flat. According to this configuration, it is possible to ensure the strength of the first substrate and the second substrate.

In addition, the present disclosure provides an optical unit including: a first element including a lens portion and formed of a curable resin; a second element overlapping the first element: and an adhesive layer containing a monodisperse spherical filler, the adhesive layer being interposed between the first element and the second element and surrounding the lens portion. According to this configuration, the thickness of the adhesive layer is uniformly ensured by the monodisperse spherical filler.

As a sixth aspect, in the fifth aspect, for example, a groove configured to accommodate the adhesive layer may not be formed in an opposing surface of the first element opposing the second element or an opposing surface of the second element opposing the first element. According to this configuration, it is possible to ensure the strength of the first element and the second element.

### REFERENCE SIGNS LIST

1: First substrate
1a: Opposing surface
10: First element
10a: Opposing surface
11: Lens portion
2: Second substrate
2a: Opposing surface
20: Second element
20a: Opposing surface
21: Lens portion
3: Laminate
4: Optical unit
40: Contour
5: Adhesive
50: Adhesive layer
6: Monodisperse spherical filler

1. A method for manufacturing a plurality of optical units by adhering a second substrate to a first substrate to produce a laminate, the first substrate being a lens wafer, the lens wafer including a plurality of lens portions and being formed of a curable resin, and then cutting the laminate between the plurality of lens portions, the method comprising:
performing surface treatment of increasing surface free energy on an opposing surface of the first substrate opposing the second substrate before adhering the second substrate to the first substrate:
applying an adhesive to the opposing surface of the first substrate after the surface treatment, the adhesive surrounding a lens portion corresponding within a contour of each of the plurality of optical units; and
superimposing the second substrate on the first substrate and curing the adhesive after the applying an adhesive.

2. The method for manufacturing an optical unit according to claim 1, wherein the surface free energy of the opposing surface of the first substrate is set from 26 to 73 mJ/m² when the surface treatment of increasing the surface free energy is performed on the opposing surface of the first substrate.

3. The method for manufacturing an optical unit according to claim 1, wherein a monodisperse spherical filler is dispersed in the adhesive.

4. The method for manufacturing an optical unit according to claim 1, wherein a portion of the opposing surface of the first substrate, which is to be adhered to the second substrate, is flat, and wherein
a portion of an opposing surface of the second substrate opposing the first substrate, which is to be adhered to the first substrate, is flat.

5. An optical unit comprising:
a first element including a lens portion and formed of a curable resin;
a second element overlapping the first element; and
an adhesive layer containing a monodisperse spherical filler, the adhesive layer being interposed between the first element and the second element and surrounding the lens portion.

6. The optical unit according to claim 5, wherein
a groove configured to accommodate the adhesive layer is not formed in an opposing surface of the first element opposing the second element and an opposing surface of the second element opposing the first element.
